(19) United States
(12) Patent Application Publication
(10) Pub. No.: US 2026/0153670 A1
(43) Pub. Date: Jun. 4, 2026

(54) ANTI-RESONANT HOLLOW CORE OPTICAL ASSEMBLY HAVING DIAGNOSTIC RING STRUCTURE AND METHOD

(71) Applicant: CORNING INCORPORATED, CORNING, NY (US)

(72) Inventors: Paulo Clovis Dainese, Jr., Painted Post, NY (US); Louis Marra, Corning, NY (US)

(21) Appl. No.: 19/278,110

(22) Filed: Jul. 23, 2025

Related U.S. Application Data
(60) Provisional application No. 63/679,228, filed on Aug. 5, 2024.

(51) Int. Cl. G02B 6/02; G01M 11/00

(52) U.S. Cl. CPC G02B 6/02328; G01M 11/332; G02B 6/02342

(57) ABSTRACT

An anti-resonant hollow core optical assembly has a central longitudinal axis extending from a first end to a second end and a diagnostic ring structure through which the central longitudinal axis extends. The diagnostic ring structure extends longitudinally from the first end to the second end, disposed azimuthally around the central longitudinal axis, comprises an outer surface at an outer radius from the central longitudinal axis and an inner surface at an inner radius from the central longitudinal axis, and has a first refractive index. A plurality of anti-resonant elements is in contact with the inner surface. The anti-resonant elements extend longitudinally from the first end to the second end and surrounds the central longitudinal axis to define an effective core region. An outer cladding surrounds the diagnostic ring structure and has a second refractive index less than the first refractive index.

This application claims the benefit of priority to U.S. Provisional Patent Application Ser. No. 63/679,228 filed on Aug. 5, 2024, the content of which is relied upon and incorporated herein by reference in its entirety.

### TECHNICAL FIELD

The present disclosure generally relates to hollow core optical assemblies, and more particularly relates to a hollow core optical assembly such as a hollow core fiber assembly having a diagnostic enabling structure that enables testing for defects in the hollow core fiber assembly.

### BACKGROUND

Optical fibers are widely utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from confinement losses and losses due to scattering, absorption, and bending. The material of the solid core can scatter and absorb the electromagnetic radiation pulses that the optical fiber is transmitting. Further, despite the total internal reflection, some of the intensity of the electromagnetic radiation can escape from the core into the cladding due to external perturbations such as bending and stresses. Confinement loss, which is loss due to leakage of modes from the core to the cladding, also degrades the optical signal. The loss of signal from the core is referred to as attenuation. The scattering, absorption, and lack of total confinement reduce the power of the electromagnetic radiation signal pulses guided by the optical fiber, which reduces the ability of the receiver to convert the pulses back into information due to a decreased signal-to-noise ratio as the fiber length increases.

To address attenuation, hollow core optical fibers are under development. Hollow core optical fibers generally do not include a core of solid material. Rather, the hollow core is a gas, such as air. Due to the absence of a solid core, it is thought that the electromagnetic radiation could transmit without as much scattering and absorption loss. Hollow-core optical fibers also exhibit low latency for optical signals, which provides flexibility in the design of optical networks and data centers.

In some instances, the hollow core optical fiber typically includes a glass cladding, which is a tube, and glass capillary tubes disposed within the glass cladding around a fiber longitudinal axis. The glass capillary tubes define an effective core region with an effective core radius within the glass cladding. Such hollow core optical fibers generally rely on anti-resonance to maintain the optical signal within the effective core region and transmit the optical signal through the hollow core optical fiber with limited confinement loss.

To verify optical performance and continuity of solid core fiber, testing methods have been developed to locate defects that may arise during fiber deployment. Such testing methods may include the use of visual fault locator or optical time domain reflectivity test procedures which rely upon light propagating through a solid core. It would be desirable to provide for an enhanced diagnostic structure that enables the testing of a hollow core fiber to identify and locate defects in structure.

### SUMMARY

The present disclosure provides for an enhanced diagnostic structure in an anti-resonant hollow core optical assembly that allows for testing of a hollow core fiber assembly.

According to a first aspect of the present disclosure, an anti-resonant hollow core optical assembly has a central longitudinal axis extending from a first end to a second end and a diagnostic ring structure through which the central longitudinal axis extends. The diagnostic ring structure extends longitudinally from the first end to the second end, disposed azimuthally around the central longitudinal axis, comprises an outer surface at an outer radius from the central longitudinal axis and an inner surface at an inner radius from the central longitudinal axis, and has a first refractive index. A plurality of anti-resonant elements is in contact with the inner surface. The anti-resonant elements extend longitudinally from the first end to the second end and surrounds the central longitudinal axis to define an effective core region. An outer cladding surrounds the diagnostic ring structure and has a second refractive index less than the first refractive index.

According to a second aspect of the present disclosure, the plurality of anti-resonant elements comprises a plurality of longitudinally extending capillaries.

According to a third aspect of the present disclosure, the plurality of longitudinally extending capillaries are connected to the inner surface of the diagnostic ring structure.

According to a fourth aspect of the present disclosure, the plurality of longitudinally extending capillaries are spaced apart from one another.

According to a fifth aspect of the present disclosure, the plurality of longitudinally extending capillaries comprise a plurality of an inner capillaries nested within a plurality of outer capillaries.

According to a sixth aspect of the present disclosure, the plurality of longitudinally extending capillaries comprise at least three capillaries.

According to a seventh aspect of the present disclosure, the plurality of anti-resonant elements comprises a plurality of arc anti-resonant features.

According to an eighth aspect of the present disclosure, the plurality of anti-resonant elements comprises a number in the range of 3-9 anti-resonant elements.

According to a ninth aspect of the present disclosure, the plurality of anti-resonant elements are in direct contact with the inner surface of the diagnostic ring structure.

According to a tenth aspect of the present disclosure, the anti-resonant hollow core optical assembly is a hollow core fiber assembly.

According to an eleventh aspect of the present disclosure, the diagnostic ring structure has a thickness in the range of approximately 1-25 microns.

According to a twelfth aspect of the present disclosure, the diagnostic ring structure is configured to diagnose a defect in the hollow core fiber assembly.

According to a thirteenth aspect of the present disclosure, the defect is diagnosed using a visual fault locator test method to launch light signals within the diagnostic ring structure.

According to a fourteenth aspect of the present disclosure, the defect is diagnosed by using an optical time domain reflectometry test method.

According to a fifteenth aspect of the present disclosure, the anti-resonant hollow core optical assembly is a hollow core preform assembly.

According to a sixteenth aspect of the present disclosure, the plurality of longitudinally extending capillaries provide a structured inner cladding.

According to a seventeenth aspect of the present disclosure, the diagnostic ring structure comprises doped silica.

According to an eighteenth aspect of the present disclosure, the plurality of anti-resonant elements are arranged symmetrically in a ring shape.

According to a nineteenth aspect of the present disclosure, the plurality of anti-resonant elements are comprised of at least one of a glass and a polymer.

According to a twentieth aspect of the present disclosure, The anti-resonant hollow core optical assembly of claim 1, further comprising an inner cladding having an interior surface and an exterior surface, the diagnostic ring structure surrounding the exterior surface of the inner cladding, the plurality of anti-resonant elements in direct contact with the interior surface of the inner cladding, the inner cladding having a third refractive index less than the first refractive index.

According to a twenty-first aspect of the present disclosure, the diagnostic ring structure directly contacts the exterior surface of the inner cladding.

According to a twenty-second aspect of the present disclosure, the anti-resonant hollow core optical assembly of claim 1, wherein the diagnostic ring structure has a first relative refractive index and the outer cladding has a second relative refractive index, and wherein a difference between the first relative refractive index of the diagnostic ring structure and the second relative refractive index of the outer cladding is in the range from 0.05% to 2.50%.

According to a twenty-third aspect of the present disclosure, a method of diagnosing a defect in a hollow core fiber assembly comprising a central longitudinal axis extending from a first end to a second end, a diagnostic ring structure through which the central longitudinal axis extends, the diagnostic ring structure extending longitudinally from the first end to the second end, disposed azimuthally around the central longitudinal axis, comprising an outer surface at an outer radius from the central longitudinal axis and an inner surface at an inner radius from the central longitudinal axis, and having a first refractive index, a plurality of anti-resonant elements in contact with the inner surface, the anti-resonant elements extending longitudinally from the first end to the second end and surrounding the central longitudinal axis to define an effective core region, and an outer cladding surrounding the diagnostic ring structure, the outer cladding having a second refractive index less than the first refractive index, the method comprising the steps of launching a light signal into the diagnostic ring structure of the hollow core fiber assembly and monitoring the light signal passing through the diagnostic ring structure.

According to a twenty-fourth aspect of the present disclosure, the method further comprises the step of analyzing the monitored light signal to detect a defect in the hollow core fiber assembly.

According to a twenty-fifth aspect of the present disclosure, the method includes the step of analyzing the light signal uses a visual fault locator test method.

According to a twenty-sixth aspect of the present disclosure, the method includes the step of analyzing the light signal uses optical time domain reflectivity test measurements.

According to a twenty-seventh aspect of the present disclosure, the plurality of anti-resonant elements comprises a plurality of longitudinally extending capillaries connected to the inner surface of the diagnostic ring structure.

According to an twenty-eighth aspect of the present disclosure, the plurality of longitudinally extending capillaries are spaced apart from one another.

According to a twenty-ninth aspect of the present disclosure, the plurality of longitudinally extending capillaries comprise a plurality of inner capillaries nested within a plurality outer capillaries.

According to a thirtieth aspect of the present disclosure, the plurality of longitudinally extending capillaries comprise at least six capillaries.

According to a thirty-first aspect of the present disclosure, the diagnostic ring structure comprises doped silica.

According to a thirty-second aspect of the present disclosure, the diagnostic ring structure has a thickness of approximately 1-25 microns.

According to a thirty-third aspect of the present disclosure, the plurality of anti-resonant elements are arranged symmetrically in a ring shape.

According to a thirty-fourth aspect of the present disclosure, a hollow core fiber has a plurality of longitudinally extending capillaries provided in a hollow core and configured to guide light along the hollow core by an anti-resonant effect. A diagnostic ring structure surrounds the hollow core fiber and extends substantially parallel to the hollow core fiber and having a first refractive index. The diagnostic ring structure has a tubular inner surface defining a circular cross-section and a tubular outer surface. An outer cladding surrounds the diagnostic ring structure and has a second refractive index. The first refractive index is greater than the second refractive index.

### BRIEF DESCRIPTION OF THE DRAWINGS

In the Drawings:

FIG. 1 is a schematic transverse cross-sectional view of one example of an anti-resonant hollow core optical assembly which may be in the form of a hollow core fiber assembly, according to one example;

FIG. 2 is a front view of a spool of a hollow core fiber assembly wound onto a spool and exhibiting a defect detected using a visual fault locator test procedure, according to one example;

FIG. 3 is a graph illustrating one example of a light signal launched into the hollow core fiber assembly and analyzed using an optical time domain reflectivity test procedure via the diagnostic ring structure to detect a defect; and

FIG. 4 is a flow diagram illustrating a method of forming an anti-resonant hollow core fiber assembly and diagnosing a defect in the anti-resonant hollow core fiber assembly, according to one example.

### DETAILED DESCRIPTION

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description, explain principles and operation of the various embodiments.

Reference will now be made in detail to the present preferred embodiments, examples of which are illustrated in the accompanying drawings. Whenever possible, the same reference numerals will be used throughout the drawings to refer to the same or like parts.

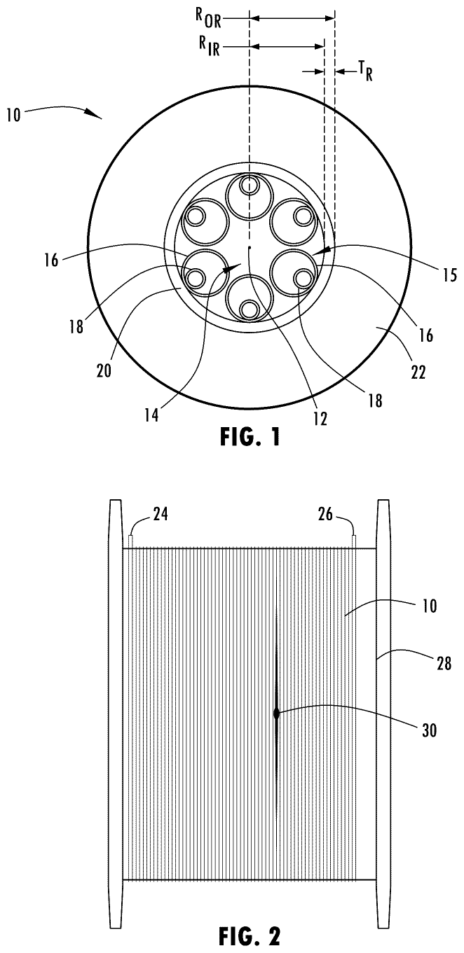

Referring to FIG. 1, an anti-resonant hollow core optical assembly 10 is generally illustrated. The anti-resonant hollow core optical assembly 10 may be configured in the form of a hollow core preform assembly or in the form of a hollow core fiber assembly that is drawn from the preform assembly in a draw furnace during fiber manufacture. The hollow core optical assembly, when configured as a hollow core fiber assembly, includes a hollow core fiber configured to guide light by an anti-resonant optical guidance effect. The hollow core fiber is surrounded by a diagnostic ring structure 20 which is configured to enable a method of testing the hollow core fiber assembly by propagating light through the diagnostic ring structure according to a test procedure to determine whether there may be a defect in the hollow core fiber assembly.

Herein, the terms anti-resonant hollow core optical assembly, hollow core fiber, hollow core fiber assembly, and hollow core waveguide and similar terms are intended to cover optical waveguiding structures configured such that light is guided by any of several guidance mechanisms such as guiding by anti-resonance, negative curvature and/or photonic bandgap, in a hollow elongate void or core with a structure of cladding having a plurality of anti-resonant elements such as a plurality of longitudinally extending capillaries or a plurality of arc anti-resonant features, for example. The anti-resonant elements such as the longitudinal capillaries or arc anti-resonant features which may comprise or define elongate holes, voids, lumina, cells or cavities which run continuously along the length of the longitudinal extent of the optical fiber, optical fiber preform, or other optical fiber assembly, substantially parallel to a diagnostic ring structure 20 which also extends continuously along the length of the longitudinal extent. The anti-resonant elements may be comprised of at least one of a glass such as silica and a polymer.

Herein, the term “refractive index” is defined as n=c/v, where c is the speed of light in vacuum and v is the phase velocity of light in the subject medium. A “refractive index profile” is the relationship between refractive index or relative refractive index and waveguide fiber radius. The “relative refractive index” is defined as Δ=100×[n(r)²−n_{cl}²)/2n(r)²], where n(r) is the refractive index at the radial distance r from the fiber's centerline, unless otherwise specified, and n_{cl} is the average refractive index of an outer cladding region of the cladding at a wavelength of 1550 nm, which can be calculated, for example, by taking “N” index measurements (n_{C1}, n_{C2}, . . . n_{CN}) in an outer annular region of the cladding and calculating the average refractive index by the following equation:

$${n}_{cl} = \frac{1}{N} {\sum }_{i = 1}^{i = N} {n}_{Ci}$$

In some embodiments, an outer cladding region may include essentially pure silica. As used herein, the relative refractive index is represented by delta or Δ and its values are typically given in units of “%,” unless otherwise specified.

According to the present disclosure, an anti-resonant hollow core optical assembly 10 may be configured as a hollow core preform assembly or a hollow core fiber assembly, both of which comprise an effective core region 14, a surrounding diagnostic ring structure 20 and a further surrounding outer cladding 22. The diagnostic ring structure 20 is made of a solid optical fiber material such as doped silica. Optical fiber testing methods can be performed on the hollow core fiber assembly by launching and propagating a light signal into the diagnostic ring structure 20 and analyzing the light signal, and the results of the test can be used to deduce or determine a likely state of the hollow core fiber assembly due to the close proximity and shared physical location and condition of the hollow core fiber and the diagnostic ring structure 20 within the same hollow core fiber assembly 10.

Referring to FIGS. 1 and 2, the anti-resonant hollow core optical assembly 10 is shown and described herein according to an exemplary embodiment configured as a hollow core fiber assembly. According to another embodiment, the anti-resonant hollow core optical assembly 10 may be configured on a larger dimensional scale as an anti-resonant hollow core preform assembly which may be used to draw and thereby form the anti-resonant hollow core fiber assembly on a much smaller dimensional scale. As such, the transverse cross-section of the hollow core preform assembly and the hollow core fiber assembly may have the same features and shape but different sized dimensions. For example, an anti-resonant hollow core preform assembly having a length of 1.5 m to 30 m and a preform diameter of 0.5 cm to 15 cm may be heated and used to draw many meters of a hollow core fiber assembly having a fiber diameter of 50 μm to 500 μm.

The anti-resonant hollow core optical assembly 10 has a central longitudinal axis 12 as shown in FIG. 1 extending from a first end 24 to a second end 26 as shown in FIG. 2 when embodied as a hollow core fiber assembly. The diagnostic ring structure 20 is cylindrical and is provided through which the central longitudinal axis 12 extends. The diagnostic ring structure 20 extends longitudinally from the first end 24 to the second end 26, disposed azimuthally around the central longitudinal axis 12, and comprises an outer surface at an outer radius R_{OR} from the central longitudinal axis 12 and an inner surface at an inner radius R_{IR} from the central longitudinal axis 12, and has a first refractive index. The diagnostic ring structure 20 has a thickness T_{R} extending the distance between the inner radius R_{IR} and the outer radius R_{OR}. The anti-resonant hollow core optical assembly 10 further includes a plurality of anti-resonant elements 15 shown in one exemplary embodiment as a plurality of longitudinally extending outer and inner capillaries 16 and 18 which are in contact with the inner surface of the diagnostic ring structure 20. The anti-resonant elements 15 extend longitudinally from the first end 24 to the second end 26 and surround the central longitudinal axis 12 to define an effective core region 14 with an effective core radius extending from central longitudinal axis 12 to the radially most inward tangent point to the anti-resonant elements 15.

In the example shown, the anti-resonant elements 15 are configured in a nested capillary arrangement that includes a plurality of paired outer capillaries 16 and inner capillaries 18 in which the inner capillaries 18 are nested within the corresponding outer capillaries 16. In the embodiment of FIG. 1, the outer capillaries 16 are in direct contact with the inner surface of the diagnostic ring structure 20 and are shown arranged symmetrically in a circle and spaced apart from one another such that there is a gap so they are not touching each other, according to one example. The inner capillaries 18 are in direct contact with an inner surface of the outer capillaries 16 at a location proximate to the direct contact location of the outer capillaries 16 to the inner surface of the diagnostic ring structure 20. When configured as a hollow core fiber assembly, the outer and inner capillaries 16 and 18 may be made of glass tubes and may have a radius of 5 μm to 30 μm and 5 μm to 15 μm, respectively, and a thickness of 250 nm to 1500 nm. The pairs of nested capillaries are within the diagnostic ring structure and surround a central cavity which defines the effective core region of the fiber assembly.

The anti-resonant hollow core optical assembly 10 further includes an outer cladding 22 surrounding the diagnostic ring structure 20. In one example, the outer cladding 22 is a solid tubular cladding and is in direct contact with the outer surface of the diagnostic ring structure 20. The outer cladding 22 has a second refractive index that is less than the first refractive index of the diagnostic ring structure 20. The outer cladding 22 may be made of silica, which may be made or doped or undoped silica. For example, the silica in the outer cladding 22 may be doped with fluorine and boron.

The diagnostic ring structure 20 has a generally ring-shaped inner surface with a substantially circular cross-section and an outer ring-shaped surface with a substantially circular cross-section, according to one example. The diagnostic ring structure 20 may be made of a doped silica or other material with a first refractive index larger than the second refractive index of the outer cladding 22. The silica in the diagnostic ring structure 20 may be doped with one or more of germanium, phosphorous and aluminum, for example. Other materials, both doped and undoped, may be used to form the diagnostic ring structure 20 and outer cladding 22. By providing a high index diagnostic ring structure 20 surrounding a plurality of anti-resonant elements 15 that define the effective core region of a hollow core fiber, the hollow core fiber assembly may be tested for defects by propagating a light signal into the diagnostic ring structure 20 and analyzing the light signal along the length of the hollow core fiber assembly to detect any irregularities of the light signal that may exist within the diagnostic ring structure which may be indicative of defects in the hollow core fiber assembly.

The diagnostic ring structure 20, having a first relative refractive index, is surrounded by the outer cladding 22 having a second relative refractive index which is lower than the first relative refractive index. As a result, light launched in single mode or multiple modes is guided for propagation along the diagnostic ring structure 20 by total internal reflection at the diagnostic ring structure-outer cladding boundary due to the difference in the first and second relative refractive indices of the diagnostic ring structure 20 and the outer cladding 22. The first and second relative refractive indices within the diagnostic ring structure 20 and the outer cladding 22 may be uniform or may be varied, i.e., grated across the transverse profile. According to one example, the diagnostic ring structure 20 may have a first relative refractive index value A in the range of 0.5% to 2.5%. According to another example, the first relative refractive index value of the diagnostic ring structure 20 may be in the range of 0.0% to 2.0%. In contrast, the outer cladding 22 may have a relative refractive index value in the range of −1.0% to 1.0%. The difference between the relative refractive index of diagnostic ring structure 20 and the relative refractive index of outer cladding 22 may greater than 0.05%, or greater than 0.10%, or greater than 0.25%, or greater than 0.50%, or greater than 0.75%, or greater than 1.00%, or greater than 1.25%, or greater than 1.50%, or greater than 1.75%, or greater than 2.00%, or in the range from 0.05% to 2.50%, or in the range from 0.10% to 2.00%, or in the range from 0.20% to 1.50%, or in the range from 0.30% to 1.00%.

In the example shown, the hollow core optical assembly 10 has six nested pairs of outer and inner capillaries 16 and 18 spaced apart and connected to the inner surface of the diagnostic ring structure 20 which defines the effective core region 14. The arrangement of the nested outer and inner capillaries 16 and 18 in a ring-shaped pattern around the inner surface of the diagnostic ring structure 20 creates a central space, cavity or void within the hollow core optical assembly. The outer and inner capillaries 16 and 18 may be made of material such as glass or polymer, for example. The outer and inner capillaries 16 and 18 have longitudinally extended capillary walls that make up a boundary that provides an anti-resonant optical guidance effect. The outer capillaries 16 in the hollow core fiber assembly are larger in diameter than the inner capillaries. The outer capillaries 16 and inner capillaries 18 may each have a thickness that defines the wavelength for which the anti-resonant optical guidance occurs.

In the example shown, six pairs of nested capillaries are evenly spaced symmetrically around the inner surface of the diagnostic ring structure 20. The number of nested capillaries extending along the inner surface of the diagnostic ring structure 20 may be in the range of three to nine, or more particularly, for example, four, five, six, seven or eight capillaries, although other numbers of anti-resonant elements may be included. It should be appreciated that the nested pairs of outer and inner capillaries 16 and 18 may be otherwise arranged surrounded by the diagnostic ring structure 20 and may be in contact with one another and thereby touching, according to other examples. It should be appreciated that the anti-resonant hollow core optical assembly 10 may have other arrangements of anti-resonant elements surrounding the effective core region 14. For example, a plurality of capillaries may be arranged in other locations, such as spaced from the diagnostic ring structure 20, and may include a structured inner cladding, for example. It should further be appreciated that the anti-resonant hollow core optical assembly 10 may employ any optical assembly having a hollow region to thereby define a hollow core.

According to another example, the plurality of anti-resonant elements 16 may be configured as a plurality of arc anti-resonant features. For example, the anti-resonant hollow core optical fiber preform assembly and the subsequently formed anti-resonant hollow core optical fiber assembly may include arcuate elements arranged azimuthally around the fiber longitudinal axis 12. Each of the arcuate elements may be disposed radially between the fiber longitudinal axis 12 and the inner surface of the diagnostic ring structure 20. The effective core region 14 can be tangential to the arcuate elements disposed radially closest to the fiber longitudinal axis 12. Further arcuate elements can be disposed radially between the innermost arcuate elements and the inner surface of the diagnostic ring structure 20. The inner surface of the diagnostic ring structure 20 can provide a plurality of recesses disposed azimuthally around the fiber longitudinal axis. The recesses in the arcuate elements may be radially aligned.

The anti-resonant hollow core optical assembly 10 when configured as a hollow core preform assembly has a size larger than the hollow core fiber assembly that is drawn from the hollow core preform assembly. According to one example, the hollow core preform assembly may have an overall diameter of 2 cm to 15 cm and a length of 1.5 m to 30 m. The diagnostic ring structure 20 may have an inner radius R_{IR} of 1.5 mm to 50 mm. The diagnostic ring structure 20 may further have a thickness T_{R} of 100 μm to 6000 μm. The outer capillaries 16 may have a radius of 0.5 mm to 9.0 mm, the inner capillaries 18 may have a radius of 0.5 mm to 4.5 mm, and the thickness of the walls of capillaries 16 and 18 may be 25 μm to 450 μm. Embodiments of hollow core preform assemblies outside of the stated range are also possible and can produce hollow core fiber assemblies within the ranges described herein through variation of the draw ratio during the fiber draw process.

In contrast, the hollow core fiber assembly drawn from the hollow core preform assembly in this example may have an overall diameter of 50 μm to 500 μm and may have a length of many meters such as hundreds or thousands of meters. The diagnostic ring structure 20 may have an inner radius R_{IR} of 5 μm to 200 μm, and a thickness T_{R} in the range of 1 μm to 20 μm, and more particularly in the range of 3 μm to 10 μm. The outer capillaries 16 may have a radius of 5 μm to 30 μm, the inner capillaries 18 may have a radius of 5 μm to 15 μm, and the thickness of the walls of capillaries 16 and 18 may be 250 nm to 1500 nm.

According to another example, the anti-resonant hollow core optical assembly may further include an inner cladding having an interior surface and an exterior surface, wherein the diagnostic ring structure 20 surrounds the exterior surface of the inner cladding, the plurality of anti-resonant elements are in direct contact with the interior surface of the inner cladding, and the inner cladding has a third refractive index less than the first refractive index. The diagnostic ring structure 20 may directly contact the exterior surface of the inner cladding in this example. As used herein, the term “contact” means direct or indirect contact. Direct contact means physically touching, whereas indirect contact means contact via an intermediate medium.

The anti-resonant hollow core optical assembly 10 may be configured as a hollow core preform assembly that in turn is used to draw a hollow core fiber assembly. The anti-resonant hollow core optical assembly 10 may be configured as a hollow core fiber assembly that is drawn from a hollow core preform assembly. Once drawn from a preform during a fiber manufacturing process, the hollow core fiber assembly may be coated with one or more coatings to provide one or more extra layers around the outer surface surrounding the outer cladding 22 which may serve as a protective jacket and the fiber assembly may be wound onto a spool.

The anti-resonant hollow core optical assembly 10 when embodied as a hollow core fiber assembly may be wound onto a spool 28 as shown in FIG. 2 during or after the fiber manufacturing process. The hollow core fiber assembly includes the first end 24 and the opposite second end 26 which may be utilized to launch and receive light to test and diagnose a defect in the hollow core fiber assembly using a visual fault locator test method, according to one example, or an optical time domain reflectometry (OTDR) test method, according to another example. The visual fault locator or OTDR test methods may utilize launch light into and receive light from diagnostic ring structure 20 to verify the optical performance and continuity of the hollow core fiber assembly. Using the visual fault locator test, a light signal may be launched into the diagnostic ring structure 20 of the hollow core fiber assembly, such as into the first end 24 and/or the second end 26, to thereby illuminate and propagate light through the entire length of the hollow core fiber assembly. The light is received and analyzed to detect a bright illuminated spot signifying the location of a defect as determined in the hollow core fiber assembly. It should be appreciated that the light may be launched into either the first end 24 or the second end 26 of the hollow core fiber assembly, or may be launched into other locations in the diagnostic ring structure 20 of the hollow core fiber assembly. It should also be appreciated that any bright spot indicative of a defect may not be visible when light is launched into the effective core region 14 of the hollow core fiber assembly rather than propagating the light within the diagnostic ring structure 20.

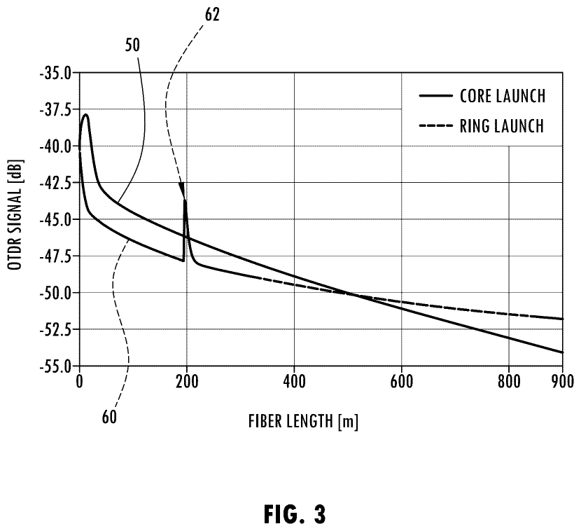

The hollow core fiber assembly may similarly be tested using the OTDR measurement test by launching light signals into one end of the diagnostic ring structure 20 to propagate through the diagnostic ring structure 20 and measuring the light signals at the same or another location of the hollow core fiber assembly. Known OTDR measurement methods may use light at wavelengths in the vicinity of 1310 nm, 1550 nm, and 1625 nm, for example. The OTDR measurement test relies on the detection of backward propagating light that arises from backscatter in the waveguide material and back-reflection from connectors, splices or flaws in the structure of the hollow core fiber assembly and may return to the launch end of the waveguide. As seen in one example in FIG. 3, light signal measurements are provided to show light signal measurements for light signals that are launched into the diagnostic ring structure 20 as shown by dashed line 60 while taking OTDR signal measurements. A corresponding measurement for light signals launched into the effective core region 14 is shown by line 50. In this example, it is observed that a peak 62 in the light signals at a length of 200 meters signifies a defect that is visible only when launched through the diagnostic ring structure 20, which may be indicative of a break or crack or other defect in the hollow core fiber assembly which may be present in the anti-resonant elements 15, and/or in the outer cladding 22.

The anti-resonant hollow core optical assembly 10 advantageously incorporates the diagnostic ring structure 20 into the hollow core preform assembly that is used to form a hollow core fiber assembly and into the resulting hollow core fiber assembly that is drawn from the hollow core preform assembly. According to one example, the hollow core preform assembly may be assembled and manufactured by forming the effective core region 14 with anti-resonant elements and inserting the effective core region 14 into the high index diagnostic ring structure 20 in the shape of a tube and heating the assembly at an elevated temperature in a redraw process to fuse the components together before drawing the fiber assembly in a draw furnace, according to one example. The high index diagnostic ring structure 20 may be composed of dope silica or a material with a refractive index larger than that of the outer cladding 22. This approach provides for an enhanced scalability of the fabrication process. Furthermore, optical alignment into the surrounding diagnostic ring structure 20 is more straightforward. The diagnostic ring structure 20 extends continuously around the effective core region 14 and light can be launched from any position.

According to one example, the diagnostic ring structure 20 may be formed by adding germanium (Ge) or any other high index dopant to a silica material during an outside vapor deposition (OVD) overclad process.

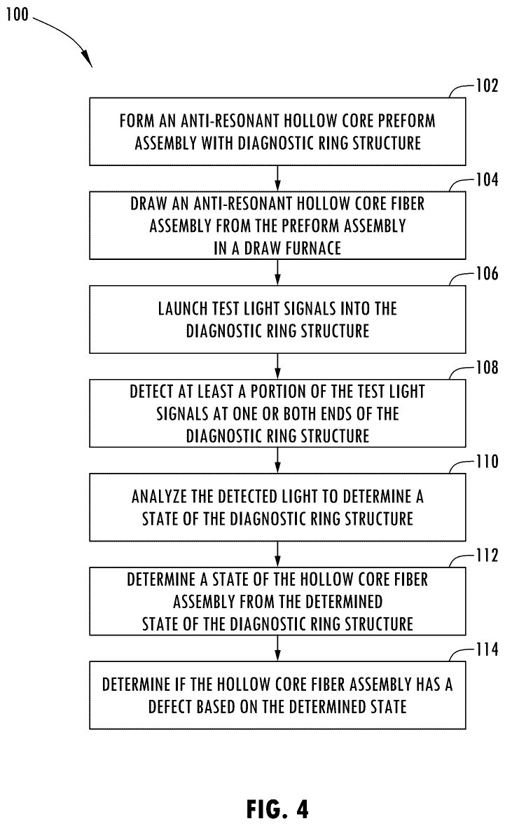

Referring to FIG. 4, a method 100 of forming a hollow core fiber assembly from an anti-resonant hollow core preform assembly having a diagnostic ring structure and testing the hollow core fiber structure is illustrated, according to one example. Method 100 begins at step 102 by forming an anti-resonant hollow core preform assembly which includes a solid core high index diagnostic ring structure. The hollow core preform assembly may be formed by forming the effective core region 14 and inserting the effective core region 14 within the diagnostic ring structure 20 which in turn is placed within the outer cladding 22, and fusing the components together at an elevated temperature of above the softening point of the glass components in a furnace pursuant to a redraw process. The hollow core preform assembly is generally configured in a size sufficient to be disposed within a draw furnace and has a diameter in length sufficient to draw a desired size and length of hollow core fiber assembly in step 104.

Next, in step 106, method 100 includes the step of testing the drawn hollow core fiber assembly by launching test light signals into the diagnostic ring structure. This may include launching the light signals into the first and/or second ends or other location within the diagnostic ring structure along the length of the hollow core fiber assembly. Method 100 then proceeds to step 108 to detect at least a portion of the test light signals at one or both ends of the diagnostic ring structure. The detected light signals are then analyzed in step 110 to determine a state of the diagnostic ring structure, such as to detect a bright illumination which may be detected using a visual fault locator test method for monitoring the light signals or which may be detected using an optical time domain refractometry test method.

At step 112, the state of the hollow core fiber assembly is determined from the determined state of the diagnostic ring structure. This determination may include inferring at any defect detected with the diagnostic ring structure is indicative of a defect in the hollow core fiber assembly such as in the effective core region 14 and/or in the outer cladding 22. Finally, at step 114, method 100 determines if the hollow core fiber assembly has a defect based on the determined state. It should be appreciated that other fiber defect or fault detection methods may be employed to inject and launch light into the diagnostic ring structure and to detect a fault in the hollow core fiber assembly based on light traveling through the diagnostic ring structure.

It will be apparent to those skilled in the art that various modifications and variations can be made without departing from the spirit or scope of the claims.

What is claimed is:

1. An anti-resonant hollow core optical assembly comprising:
a central longitudinal axis extending from a first end to a second end;
a diagnostic ring structure through which the central longitudinal axis extends, the diagnostic ring structure extending longitudinally from the first end to the second end, disposed azimuthally around the central longitudinal axis, comprising an outer surface at an outer radius from the central longitudinal axis and an inner surface at an inner radius from the central longitudinal axis, and having a first refractive index;
a plurality of anti-resonant elements in contact with the inner surface, the anti-resonant elements extending longitudinally from the first end to the second end and surrounding the central longitudinal axis to define an effective core region; and
an outer cladding surrounding the diagnostic ring structure, the outer cladding having a second refractive index less than the first refractive index.

2. The anti-resonant hollow core optical assembly of claim 1, wherein the plurality of anti-resonant elements comprises a plurality of longitudinally extending capillaries.

3. The anti-resonant hollow core optical assembly of claim 2, wherein the plurality of longitudinally extending capillaries are connected to the inner surface of the diagnostic ring structure.

4. The anti-resonant hollow core optical assembly of claim 3, wherein the plurality of longitudinally extending capillaries are spaced apart from one another.

5. The anti-resonant hollow core optical assembly of claim 3, wherein the plurality of longitudinally extending capillaries comprise a plurality of an inner capillaries nested within a plurality of outer capillaries.

6. The anti-resonant hollow core optical assembly of claim 1, wherein the plurality of anti-resonant elements comprises a plurality of arc anti-resonant features.

7. The anti-resonant hollow core optical assembly of claim 1, wherein the plurality of anti-resonant elements are in direct contact with the inner surface of the diagnostic ring structure.

8. The anti-resonant hollow core optical assembly of claim 1, wherein the anti-resonant hollow core optical assembly is a hollow core fiber assembly.

9. The anti-resonant hollow core optical assembly of claim 8, wherein the diagnostic ring structure has a thickness in the range of approximately 1-25 microns.

10. The anti-resonant hollow core optical assembly of claim 1, wherein the anti-resonant hollow core optical assembly is a hollow core preform assembly.

11. The anti-resonant hollow core optical assembly of claim 1, wherein the diagnostic ring structure comprises doped silica.

12. The anti-resonant hollow core optical assembly of claim 1, wherein the plurality of anti-resonant elements are arranged symmetrically in a ring shape.

13. The anti-resonant hollow core optical assembly of claim 1, wherein the plurality of anti-resonant elements are comprised of at least one of a glass and a polymer.

14. The anti-resonant hollow core optical assembly of claim 1, further comprising an inner cladding having an interior surface and an exterior surface, the diagnostic ring structure surrounding the exterior surface of the inner cladding, the plurality of anti-resonant elements in direct contact with the interior surface of the inner cladding, the inner cladding having a third refractive index less than the first refractive index.

15. The anti-resonant hollow core optical assembly of claim 1,
wherein the diagnostic ring structure has a first relative refractive index and the outer cladding has a second relative refractive index, and
wherein a difference between the first relative refractive index of the diagnostic ring structure and the second relative refractive index of the outer cladding is in the range from 0.05% to 2.50%.

16. A method of diagnosing a defect in a hollow core fiber assembly comprising a central longitudinal axis extending from a first end to a second end, a diagnostic ring structure through which the central longitudinal axis extends, the diagnostic ring structure extending longitudinally from the first end to the second end, disposed azimuthally around the central longitudinal axis, comprising an outer surface at an outer radius from the central longitudinal axis and an inner surface at an inner radius from the central longitudinal axis, and having a first refractive index, a plurality of anti-resonant elements in contact with the inner surface, the anti-resonant elements extending longitudinally from the first end to the second end and surrounding the central longitudinal axis to define an effective core region, and an outer cladding surrounding the diagnostic ring structure, the outer cladding having a second refractive index less than the first refractive index, the method comprising the steps of:
launching a light signal into the diagnostic ring structure of the hollow core fiber assembly; and
monitoring the light signal passing through the diagnostic ring structure.

17. The method of claim 16, further comprising the step of:
analyzing the monitored light signal to detect a defect in the hollow core fiber assembly.

18. The method of claim 16, wherein the plurality of anti-resonant elements comprises a plurality of longitudinally extending capillaries connected to the inner surface of the diagnostic ring structure.

19. The method of claim 18, wherein the plurality of longitudinally extending capillaries comprise a plurality of inner capillaries nested within a plurality outer capillaries.

20. The method of claim 16, wherein the diagnostic ring structure comprises doped silica.

21. The method of claim 16, wherein the diagnostic ring structure has a thickness of approximately 1-25 microns.
